(19) United States
(12) Patent Application Publication
(10) Pub. No.: US 2016/0362934 A1
(43) Pub. Date: Dec. 15, 2016

(54) Adjustable Width Step Store Gate

(71) Applicant: Robert Lee Swafford, West Frankfort, IL (US)

(72) Inventor: Robert Lee Swafford, West Frankfort, IL (US)

(21) Appl. No.: 15/205,844

(22) Filed: Jul. 8, 2016

Related U.S. Application Data
(63) Continuation-in-part of application No. 13/915,536, filed on Jun. 11, 2013, now Pat. No. 9,428,957.
(60) Provisional application No. 61/689,658, filed on Jun. 11, 2012.

(51) Int. Cl. E06B 11/02; E06B 3/92; E05D 3/02; E05D 5/06; E06B 9/06

(52) U.S. Cl. CPC E06B 11/026; E05D 5/06; E06B 9/0623; E05D 3/02; E06B 3/921; E05Y 2900/40; E06B 2009/002

(57) ABSTRACT

The disclosure is a gate that may be adjusted to the width of a passageway by use of bottom and top telescoping beams: The device rotates on a new designed vertical Pivot Post: The hollow core pivot post encases the pivotally mounted ends of the bottom and top telescoping beam: These telescoping beams each have a lengthwise open track, facing one to the other, and thereby entrap the ends of a pre-assembly of a plurality of vertical blocking devices that are linked together by a bottom and a top Bungee Cord: The two Bungee Cords maintain equal spacing of vertical devices, as the gate width is adjusted. Closing the gate across a passageway, the horizontal beams are lowered into a “Y” tapered receiver bracket assembly. The lifting end gate will rotate to a stairway wall or an adjoining surface for storage. An existing gate structure will adjusted to fit a 36 inch to a 56 inch passageway.

### CROSS-REFERENCE TO RELATED APPLICATIONS

THIS APPLICATION CLAIMS PRIORITY TO A CONTINUATION IN PART OF NON-PROVISIONAL APPLICATION SER. NO. 15/011,551 WHICH CLAIMS PRIORITY TO APPLICATION SER. NO. 13/888,251 FILED ON May 6, 2013 WHICH CLAIMS PRIORITY TO PROVISIONAL APPLICATION NO. 67/687,908 FILED ON May, 4, 2012 ALSO NON-PROVISIONAL APPLICATION SER. NO. 13/915,536 FILED ON Jun., 11, 2013 WHICH CLAIMS PRIORITY TO PROVISIONAL APPLICATION NO. 61/689,658 FILED ON Jun. 4, 2012

### BACKGROUND

Through many years, gate builders designed and built the most rigid gates they could build. Searching the market in 2012, no gate was found for use at a stairway. Some “Snap-in Blocking Devices” are used. This lifetime experienced builder and inventor gave much thought then designed and built the Pivot Post Step Store Gate and followed that a month later with an all purpose Classic Step Store safety Gate. Patent searches have found; no preceding gates built in the described manner of this inventor's gates. This inventor followed this with the “T” Top Step store gate; application Ser. No. 15/011,551. This dreamer contemplated building an adjustable width gate. Previous adjustable width rigid gates used side by side gate sections, sliding on variant track configurations.

Now this inventor has a working model of an adjustable width step store gate using special telescoping beams to adjust the width of the blocking device. This application is somewhat advanced from the early working plans and a model which has been used several months.

Telescoping beams required a special mounting device in which the beams are pivotally mounted to allow lifting action. Equal spacing for a changing width gate took some experimenting and that was accomplished. Locking the telescoping beams to exact size needed took a lot of thought, and that too is accomplished.

### BRIEF DESCRIPTION OF THE DRAWINGS

FIG. 1: Front elevation of the present invention, an adjustable width step store gate in closed position; Includes a side view of the receiver bracket assembly, as viewed holding the gate level.

FIG. 2: Plan view of the present invention, details a top view of the telescoping, locking to length, beam system, of the non-rigid gate, and is secured level in the receiver bracket assembly.

FIG. 3: Viewing the lifting and horizontal rotating end of the present invention.

FIG. 4: Viewing the step store gate in the storage position, rotated to, and placed along a wall.

FIG. 5: A plurality of vertical blocking members, in a layered sectional view of the present invention; with attached bottom and top bungee cords displayed.

FIG. 6: Displays the bottom pivot post mounting bracket; with an attached vertical pivot pin, projecting upward; allowing horizontal rotation of the present invention.

FIG. 7: Displays the top pivot mounting bracket; with attached vertical pivot pin projecting downward securing and allowing horizontal rotation of the present invention.

FIG. 8: Pivot post layout for the three vertical surfaces, also a bottom and top of a vertical pivot post.

FIG. 9: Side view of the pivot post of the present invention, also a top view 1-1.

FIG. 10: Displays the open portion of the pivot post of the present invention, in-which the horizontal beams will insert and are there held in place by pivot pins; also a top view 1-1.

FIG. 11: Perspective view of the vertical pivot post of the present invention, in which the bottom and the top, horizontal beams are mounted by use of pivot pins.

FIG. 12: Sectional perspective view of the bottom end pivot pot assembly of the present invention.

FIG. 13: Sectional perspective view of top end of the pivot post assembly, of the present invention;

FIG. 14: Top view of the bottom adjustable telescoping beam, of the present invention with a lengthwise open track of sufficient width, for vertical pickets to move freely within.

FIG. 15: Plan view, of the top adjustable telescoping beam, of the present invention; and is a flip image of FIG. 14: The hidden under surface view is a lengthwise open track.

FIG. 16: Front elevated view, of a top or a bottom, telescoping horizontal beam; displaying the pivot mounted first section, inserted into the slightly larger lifting end, with end cap:

FIG. 17: is a front elevated view, of a top or a bottom, adjustable telescoping horizontal beam, of the present invention; and is adjusted to the shortest length: An open end view is included, 42-42.

FIG. 18: Side view of an end cap for the lifting end of each horizontal beam, shaped to press and bond into the beam, with a flanged rectangular surface to place in the gate receiver bracket.

FIG. 19 is a sectional front elevation of the present invention, with horizontal beams placed in receiver brackets, displaying the narrow view of the gate receiver brackets, mounted to a vertical beam; composing a receiver bracket assembly.

FIG. 20 is a cross sectional view of the present invention illustrating the gate resting in gate receiver brackets, mounted to a vertical beam; composing the receiver bracket assembly.

FIG. 21 is a sectional top or plan view of the present invention; and is a sectional horizontal beam end, placed in a gate receiver bracket, of a receiver bracket assembly,

FIG. 22 is a top plan view of FIG. 20; and is a sectional of a horizontal beam in a receiver bracket assembly, of the present invention.

### REFERENCE NUMBERS

Vertical pivot post 1 Bottom of pivot post 111 Top of pivot post 112

Rear panel of pivot post 113 Drilled holes in pivot bracket assembly 156

Bottom pivot bracket assembly 20 Top pivot bracket assembly 21

Vertical pivot pins or locations 6 Plastic washers 7 Horizontal pivot pins 15

First inserting horizontal beam 40 Second, outer slip over beam 42

Telescoping beams 444 Drilled pilot holes in inner horizontal beam 11

Slots in outer telescoping beams 12 Locking screws for telescoping beams 9

Horizontal beam end cap 54 Open Track 53 Bungee Cord 50

Vertical pickets or blocking members 5 Vertical pickets drilled for pivot pins 55

(Optional) Tapered washers 46 Horizontal beam receiver Brackets 10

Receiver bracket assembly 100 (Optional) Velcro pads 101 Top beam bracket 8

### DETAILED DESCRIPTION OF DRAWINGS

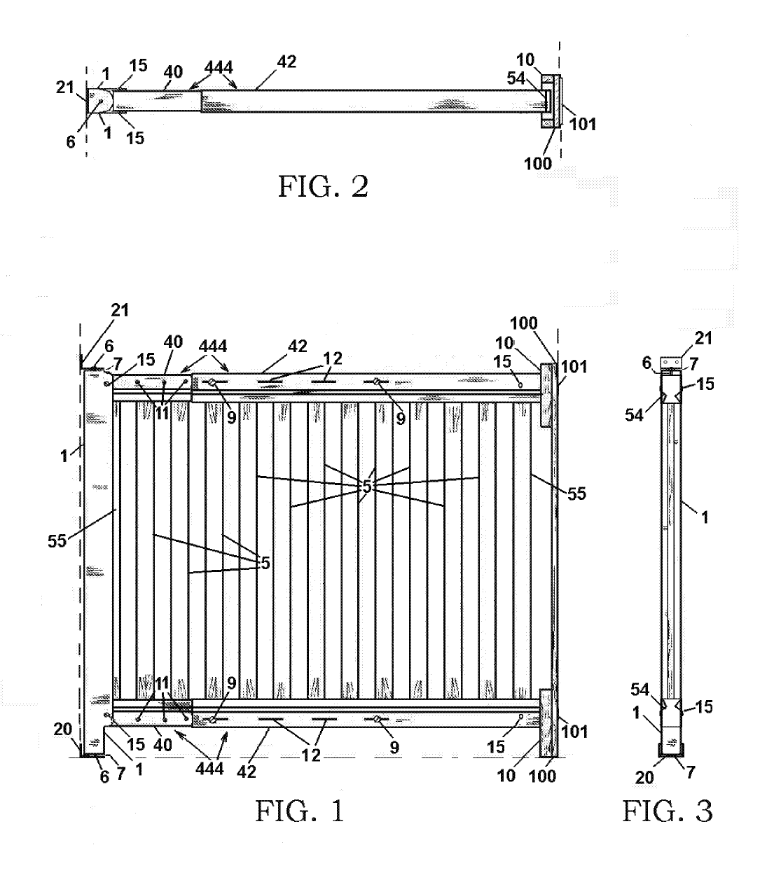

Sheet 1/8, FIG. 1 is a front elevation of the present invention, positioned across a passageway, restricting access in a closed position. Major items displayed are the pivot post 1, bottom and top telescoping beams 444, and gate receiver brackets 10: Also beam 40 with inline locking holes 11 and slip over lifting end beam 42 with lengthwise slots in the outside beam 42, providing access to inline spaced holes 11 in the inside beam 40, for inserting screws 9 that lock the telescoping beam 444 to a precise length. Vertical pickets 55 and vertical pickets 5 are displayed along with the pivot post 1. The lifting end of the horizontal beams 42 are positioned in receiver brackets 10, that are attached to a vertical beam, composing the receiver bracket assembly 100

FIG. 2 is a plan view showing the top mounting bracket 21 and a top view of the telescoping beam 444, and gate receiver brackets 10 attached to vertical beam composing bracket assembly 100.

FIG. 3 is an end view of the gate assembly with pivot post 1 in place on the bottom mounting bracket 20 and spacer washer 7, and a top mounting bracket 21 with the pivot pin 6 projecting down through a spacer washer 7 into the pivot post 1. Telescoping beam end caps 54 are also in view.

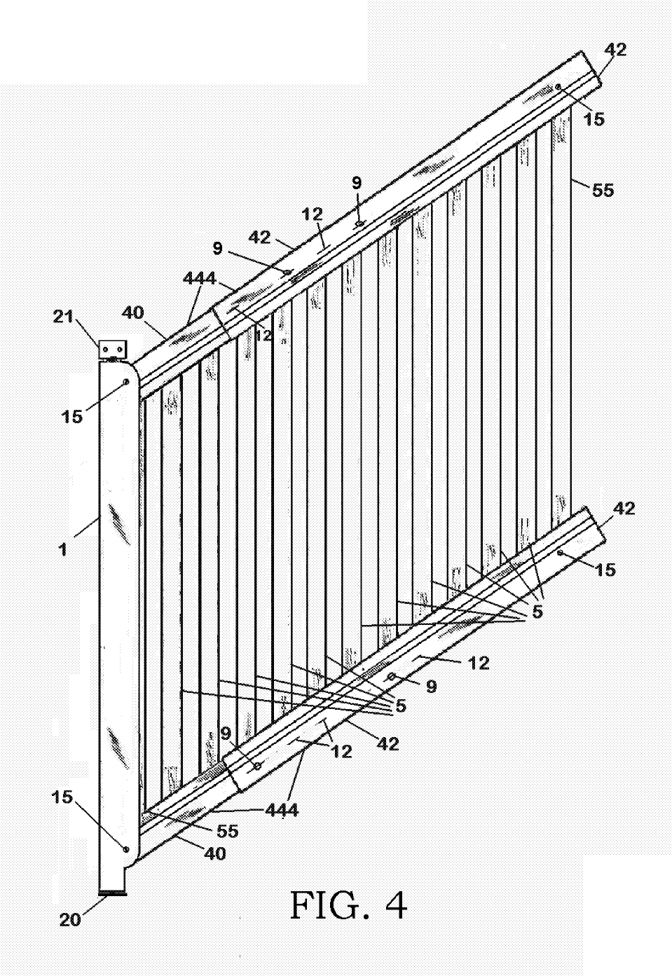

2/8, FIG. 4 indicates the lifted position of the gate device, with the first bottom beam 40 and second top beam 40, mounted within the pivot post 1, with a first bottom horizontal pivot pins 15 and a second top horizontal pivot pins 15, providing lifting action; and second larger lifting beam 42 slips over each first section of the beam 40 composing each telescoping beam 444. Also vertical pickets 5 are displayed. Bottom mounting bracket assembly 20 with a first projecting pivot pin 6 and washer 7, and top mounting bracket 21 with a second top pivot pin 6 projecting down through a washer 7; allow horizontal rotation of the pivot post 1. The present invention uses a new, folded to shape, pivot post 1 as a major structure of the gate, providing swinging action, rotating horizontally one hundred and eighty degrees or more; and providing mounting within the pivot post 1 of the adjustable length lifting end beams 444; providing encasement of the vertical pickets 5 and pivoting pickets 55.

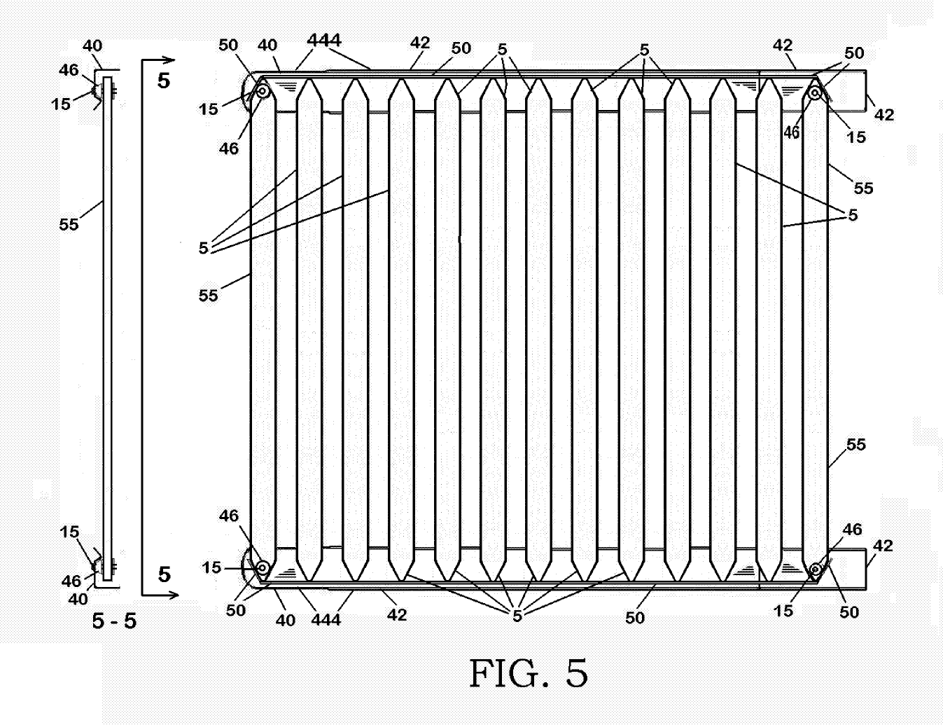

Sheet 3/8, FIG. 5 is a split sectional of the telescoping beams 444, and discloses the working system; whereas a first bottom Bungee Cord 50 spans the width of the gate, and is firmly attached at each end, to a pivotal mounted vertical picket 55 at the first end and the second end: The vertical picket 5 are evenly spaced, and the first pointed bottom end of each picket is attached to a first flat bungee cord: A second top Bungee Cord 50 spans the width of the gate, and is firmly attached to the top second end of each pivotal mounted vertical picket 55 at the first end and the second end:

The vertical picket 5 are evenly spaced, and the second top pointed end of each picket 5 is attached to the top second flat bungee cord 50. The blocking device of vertical pickets 5 is then ready to install within the open tracks 53 of the bottom and top telescoping beams 444, thereafter attached within the hollow core pivot post 1 and evenly span the width of the gate as further described.

The first bottom telescoping beam 444 is inserted into the first bottom end of the pivot post 1, in alignment with the bottom provided drilled holes 15, and a first pivot pin 15, threaded within is placed upwards through the pivot post 1, and into the first end of telescoping beam 444 and a tapered washer 46 is installed: The first bottom end of the first picket 55 is placed on the first pivot pin 15, as the pivot pin 15 is further inserted, passing through a second tapered washer 46; whereby a screw in pivot pin 15 device is inserted downwards into the inside threads of the first pivot pin 15, and tightened in place; thereby pivot mounting the bottom telescoping beam 444.

The second top telescoping beam 444 is inserted into the second top end of the pivot post 1, in alignment with the provided top drilled holes 15, and a second pivot pin 15, threaded within is placed upwards through the pivot post 1, and into the first end of the second telescoping beam 444 and a tapered washer 46 is installed: The second top end of the first picket 55 is placed on the second pivot pin 15, as the pivot pin 15 is further inserted, passing through a second tapered washer 46; whereby a second screw in pivot pin 15 device is inserted downwards into the inside threads of the second pivot pin 15, and tightened in place; thereby pivot mounting the top telescoping beam 444.

The stretchable blocking assembly of vertical pickets 5 is aligned within the open tracks of the bottom and the top horizontal beams 444, as the first end of the said assembly is now secured in place. Pivotal mounting of the second bottom end pivotal picket 55 device begins by alignment of the third pivot pin 15 upwards through the second end of the bottom telescoping beam 444, the third pivot pin 15, passing through an additional tapered washer 46, continuing through the bottom end of the second vertical pivotal mounting picket 55, and passing through an additional 6^{th} tapered washer 46; whereas a third screw-in pivot pin 15 passes downward through a provided drilled hole 15, into the third inside threaded pivot pin 15; and is thereby tightened in place.

Pivotal mounting of the second top end of the pivotal picket 55 device begins by alignment of the fourth pivot pin 15 upwards through the second end of the top telescoping beam 444, the fourth pivot pin 15, passing through a seventh tapered washer 46, continuing through the top end of the second vertical pivotal mounting picket 55, and passing through an additional 8^{th} tapered washer 46; whereas a fourth screw-in pivot pin 15 passes downward through a provided drilled hole 15, into the fourth inside threaded pivot pin 15; and is thereby tightened in place; thereby making a connecting link between the top telescoping beam 444, and the bottom telescoping beam 444; whereas the vertical pickets 5, are all entrapped within the open tracks; thereby the gate is near completion.

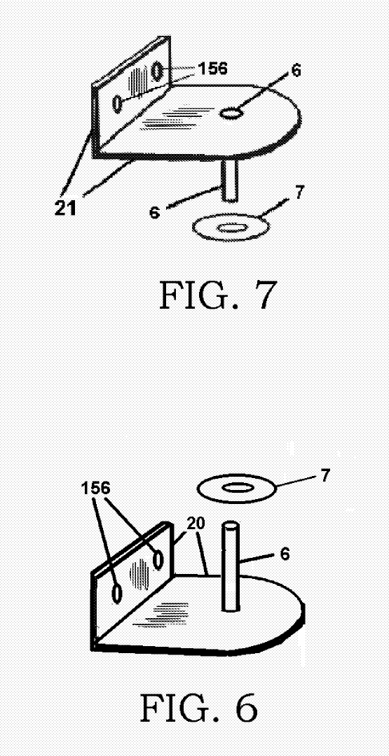

Sheet 4/8, FIG. 6 shows details of a bottom mounting bracket 20, having two drilled holes 156 for mounting to a vertical surface; and illustrates a vertical protruding pivot pin 6 that penetrates the bottom surface 111 of the pivot post 1, with a plastic washer 7 to smooth the action. FIG. 7 shows details of a top mounting bracket 21 having two drilled holes 156, for mounting to a vertical surface; and illustrates a vertical protruding pivot pin 6 that penetrates the top surface 112 of the pivot post 1, with a plastic washer 7 to smooth the action.

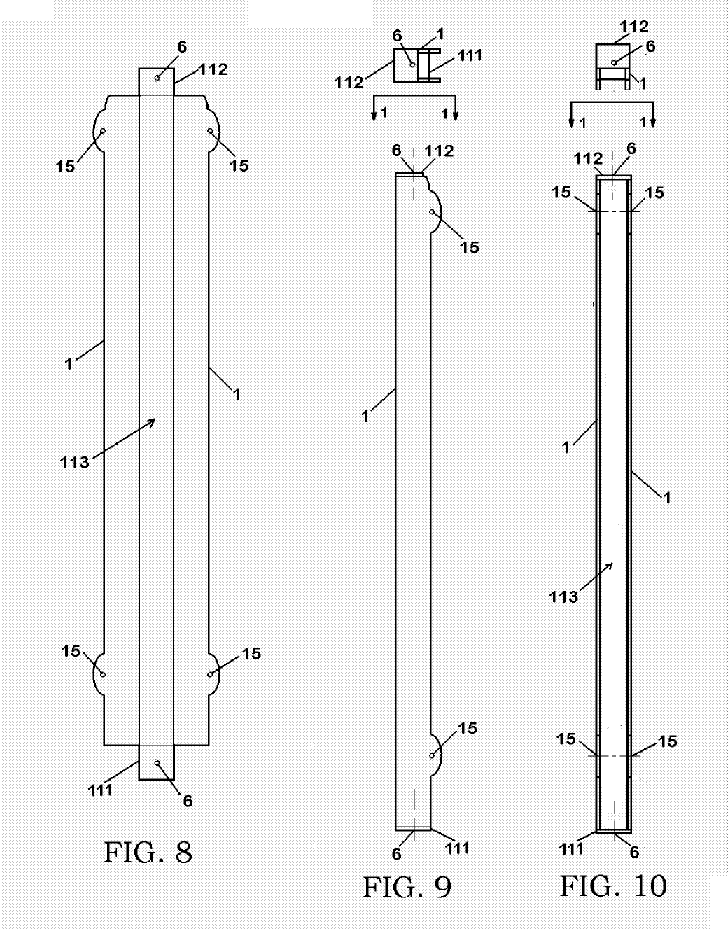

Sheet 5/8: FIG. 8, detailed drawings of the pivot post 1 are on a layout template displaying the two matching parallel panels 1 with a center panel 113 composing the three vertical surfaces and includes a bottom surface 111 and a top surface 112 attached to the center panel 113, The pivot post 1 folds ninety degrees at each interior line to attain its shape, with surface 113 joining all surfaces together; the pivot post 1 shape may vary such as drawing FIG. 1 or FIG. 11, pivot post 1.

FIG. 9 is a side view after folded into pivot post 1, and illustrates the bottom 111 and top 112, and line 6 illustrates the vertical pivot pin 6 location, as horizontal pivot pin 15 locations are displayed in each drawing: FIG. 10 displays the open view of the pivot post 1; and shows bottom 111 and top 112 with the center portion now the inside surface of the common connecting member 113 and shows horizontal pivot pins 15 locations, and locations of vertical pivot pins 6.

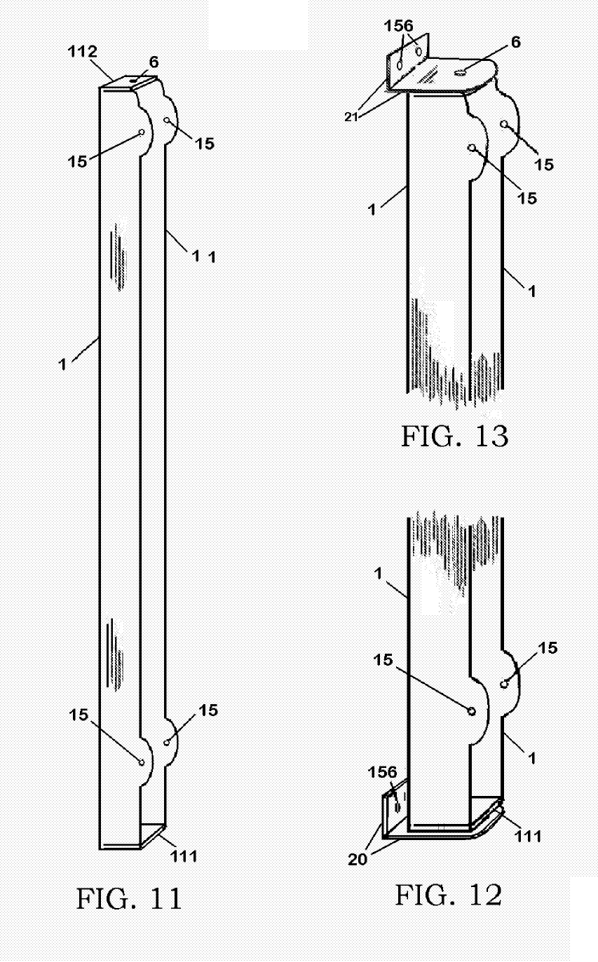

Sheet 6/8, FIG. 11 Perspective view displays the twin vertical surfaces of pivot post 1 attached to bottom or base 111 and top 112, and the top pivot pin 6 location also horizontal pivot pin 15 locations: FIG. 12 is a bottom sectional perspective of the of pivot post 1 and bottom 111 with pivot pin location 15, mounting location of bottom horizontal beam 40; also illustrating a bottom pivot bracket 20 with mounting holes 156:

FIG. 13 is a top sectional perspective of pivot post 1, and pivot pin 15 mounting location, of top horizontal beam 40; also illustrating a top mounting pivot bracket 21 and location of vertical pivot pin 6, and displays mounting screw holes 156:

The above defined pivot post 1, provides for a first bottom horizontal beam 40 mounting area with two inline pivot pin holes 15, and a second top mounting area of pivot post 1, and provides for a first top horizontal beam 40 mounting area with two inline pivot holes 15, thereby providing pivotal mounting locations 15 for inserting a first bottom telescoping beam 444, with two inline holes 15, centered in the rounded mounting end whereby a first single horizontal pivot pin 15 passes through the four inline drilled holes 15 thereby mounting a first bottom telescoping beam 444, and in a like manner, mounting a second top telescoping beam 444, attached with a second horizontal pivot pin 15 passing through four inline holes 15, to pivotally mount near the top of pivot post 1,

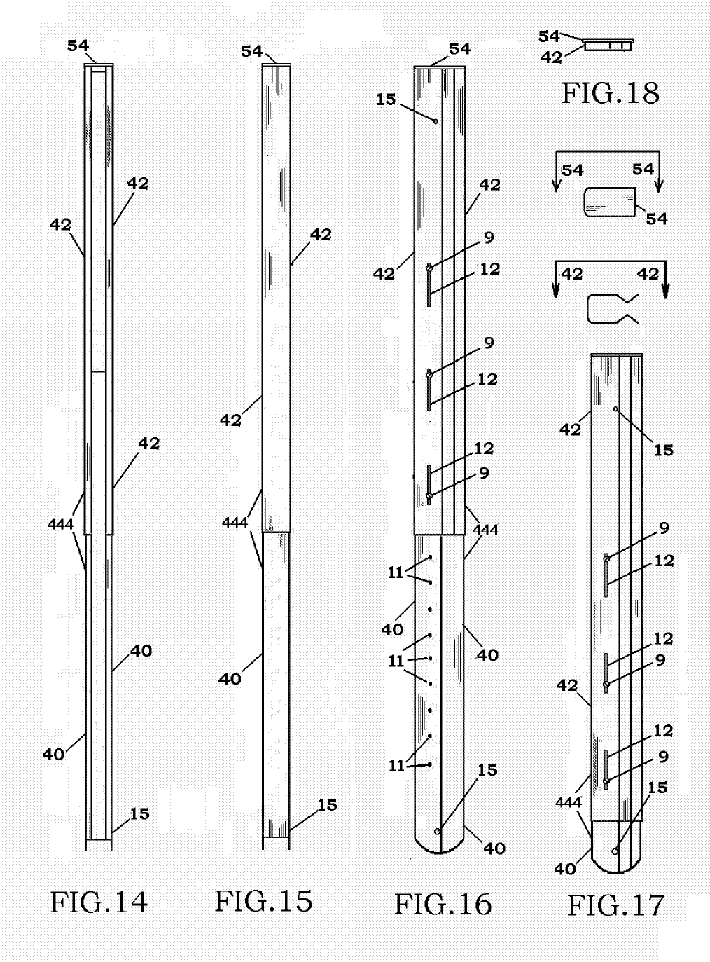

Sheet 7/8, FIG. 14 displays a top view of the bottom telescoping beam 444, with a center open track area 53; the lifting end of the telescoping beam 42 has an end cap 54. The lifting end 42 slips over the mounted end 40 creating an adjustable length beam 444.

Sheet 7/8, FIG. 15 displays a top view of the top telescoping beam 444 and an end cap 54 in the lifting end of the telescoping beam 42. The lifting end 42 slips over the mounted end 40 creating an adjustable length beam 444.

FIG. 16 is a front erected view of the bottom or the top telescoping beam 444; whereby the rounded first end beam 40 fits inside of the pivot post 1 and pivotally mounts with a first bottom pivot pin 15 near the bottom of the pivot post 1: A second top telescoping beam 444; with a rounded first end beam 40 fits inside of the pivot post 1 near the top, and pivotally mounts with a second top pivot pin 15 near the top of the pivot post 1; thereafter the blocking assembly is installed. The slip over larger beam 42, has lengthwise slots 12 for locking screws 9 to pass through, and anchor into pre-drilled holes 11, thus securing the length of the telescoping beam 444.

FIG. 17 is a front view; shortest position of the bottom or the top telescoping beam 444. Slots 12 and lock screws 9 are indicated. An end view 42-42 indicates the shape of the open track 53 54-54 illustrates the inserted extended end cap 54 for the bottom and the top telescoping beam 444.

FIG. 18 is a side view drawing of an end cap 54 that fits within the end of the bottom telescoping beam 444 as a second end cap 54 fits within the end of the top telescoping beam 444. The end caps each have an extended flanged end, rectangular in shape. The end caps 54, press into the lifting end of each telescoping beam 444 and are bonded in place.

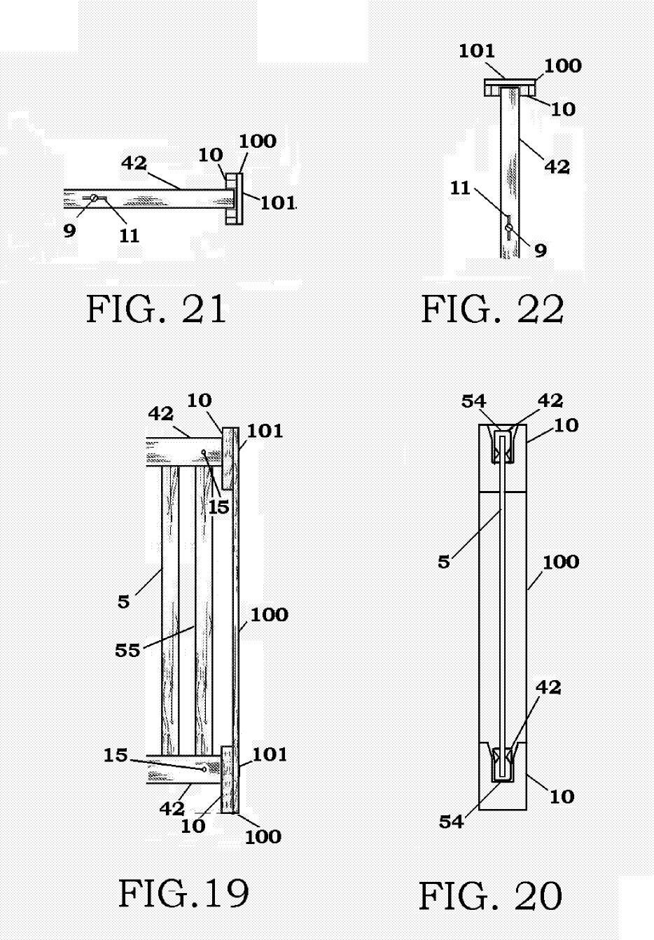

Sheet 8/8, FIG. 19: Sectional view of the lifting end of the beams 42 of the described gate, positioned in the two receiver brackets 10, assembly unit 100 including the vertical beam, with optional Velcro Pads 101.

FIG. 20 is a front facing sectional of FIG. 20 of the receiver bracket 10, assembly 100, composed of two receiver brackets 10 attached to a vertical beam 100 that may be mounted to a vertical surface or a handrail assembly, whereas Velcro pads 101 will hold in location, as straps attach and hold the device solid. Vertical picket 5 is in the two beams 42 open track areas 53, facing one to the other.

FIG. 21 is a plan view or top view of FIG. 19 with beam 42 resting in a receiver bracket 10 attached to the vertical beam 100; and displays a locking screw 9 anchoring beam 42 to beam 40.

FIG. 22 is a top sectional view of drawing FIG. 20 the larger end beam 42 of telescoping beam 444. The device was first designed with locking screws 9 on the top surface, and that remains is an option.

1; Adjustable width a non-rigid residential or commercial step store gate apparatus; composed of a vertical pivot post entailing an open side, providing internal mounting of bottom and top telescoping beams; each having an open track area the full length of each beam, with the open tracks facing one to the other; whereas a plurality of vertical pickets are equally spaced side by side, parallel one to another, whereby a bottom and a top Bungee Cord, are attached to the respective end of each vertical picket, thereby forming a flexible, expandable blocking device inserted within the open tracks, and entrapped within and between the bottom and top telescoping beams; whereas the above described device may be used to control traffic at a stairway or any passageway; whereas the pivot post is held in place with a first bottom mounting bracket providing a vertical pivot pin projecting upwards and a second top mounting bracket with a pivot vertical pin projecting downwards; thereby providing horizontal rotation of the assembly; whereby a first horizontal pivot pin provides internal pivotal mounting of the first bottom horizontal beam within the pivot post, as a second horizontal pivot pin provides mounting of the second top horizontal beam; furthermore each respective horizontal pivot pin passes through the respective ends of the first vertical picket of the expandable blocking device, is thereby mounted within the pivot post; whereby the second end vertical picket of the stretch assembly, pivotally mounts near the lifting ends of the telescoping beams with a third horizontal pivot pin passing through the bottom lifting end of said beam and corresponding end vertical picket, as a fourth horizontal pivot pin provides the final top pivot connection, thereby providing an adjustable width gate; whereas of the telescoping gate beams are adjusted and locked to precise length, making near contact with a second wall or vertical surface, and are thereby placed in receiver brackets securing the gate in level closed position across a stairway or passageway, thereby providing passage control for the general public.

2; the gate apparatus of claim 1;
further comprising a special designed pivot post of hollow structure, with one open side provided; to accommodate interior mounting a first bottom horizontal beam with a lifting end; and a second top horizontal beam with a lifting end; whereas bottom and top pivot post surfaces each have a center drilled pivot hole to receive vertical pivot pins; thereby allowing horizontal rotation of the post and gate assembly.

3; the gate apparatus of claim 1;
also providing a bottom and a top pivot post mounting bracket, each consisting of a vertical mounting flange with two mounting holes to attach to a vertical surface, and a horizontal flange projecting outwards; each assembled with a vertical pivot pin projecting through a drilled hole, to project into the pivot post; thereby holding the pivot post in vertical position, and allowing horizontal rotation of the pivot post.

4; the gate apparatus of claim 1;
and a first bottom horizontal beam, of proper measure to pivotally mount within of the first bottom end of the vertical pivot post; whereas a full length longitudinal open track is on the top of said beam; furthermore a second top mounted horizontal beam of proper thickness pivotally mounts within the second top end of the vertical pivot post, providing a full length open longitudinal track on the bottom surface, of the top beam; thereby providing two longitudinal tracks facing one to the other; thereby providing an entrapment, for the bottom and top ends, of a vertical member blocking assembly; furthermore a line of equally spaced drilled holes is required, starting at the mounting end and continuing the full length, of each above described horizontal beams; thereafter provided for locking screws in a telescoping beam assembly.

5; the gate apparatus of claim 1;
also telescoping beams, whereby a second larger bottom horizontal beam of proper measure with a top open track, will slip over the first bottom mounting end beam, and provides a full length, open longitudinal track area on the top of said beam; thereby providing an adjustable length longitudinal track; whereby a second top horizontal beam of proper measure to fit outside of the first top mounting end beam; thereby providing a full length open longitudinal track area, on the bottom surface of the top telescoping beam; thereby providing an adjustable length longitudinal track; therewith providing a line of slots, that correspond in alignment with a line of holes, in the smaller inside bottom and top beam; thereafter used for inserting locking screws in the adjustable bottom and top telescoping beams; thereby securing the adjusted length of each telescoping beam.

6; the gate apparatus of claim 1;
also the use of a bottom and a top Bungee Cord; here used to provide equal spacing of an assembly of a plurality of vertical members, as horizontal telescoping beams are adjusted to accommodate the width of a passageway or stairway; whereas each Bungee Cord is attached to the corresponding end of each equally spaced vertical members; thereafter the Bungee Cord assembly is installed and entrapped in the provided corresponding open tracks; whereby Bungee Cords are concealed within the telescoping beams, as they maintain equal spacing of vertical pickets, beams or other blocking devices, of the adjustable width blocking apparatus or step store gate.

7; the gate apparatus of claim 1;
also a vertical receiver bracket assembly secures the gate in the closed position, providing a bottom and a top “Y” tapered horizontal beam receiver brackets; a first receiver bracket, attached to the bottom of a vertical beam, and a second receiver bracket mounted at the top of the aforementioned beam, for a secure mounting apparatus; whereby the receiver assembly may be attached to a wall or vertical surface, or may be attached to a railing by use of existing devices.

8; the gate apparatus of claim 1;
and an open position; wall mounted top beam securing device; whereby this device secures the top lifting beam parallel to and along a wall or vertical surface, to prevent movement of the top handhold gate beam, while the blocking device is in the open step store position; and is thereby provided for safety.
